(19) United States
(12) Patent Application Publication
(10) Pub. No.: US 2016/0019822 A1
(43) Pub. Date: Jan. 21, 2016

(54) Event bunting flag and related method

(71) Applicant: Martha Long, Clayton, NC (US)

(72) Inventor: Martha Long, Clayton, NC (US)

(21) Appl. No.: 14/804,271

(22) Filed: Jul. 20, 2015

Related U.S. Application Data
(60) Provisional application No. 62/026,068, filed on Jul. 18, 2014.

(51) Int. Cl. G09F 17/00; D05B 29/00; D05B 1/02; D05B 3/12

(52) U.S. Cl. CPC G09F 17/00; D05B 3/12; D05B 29/00; D05B 1/02

(57) ABSTRACT

An event bunting flag provides decoration for holidays, birthdays, and other occasions. The bunting flag lays flat against a surface and does not requires a flag pole and can be used to decorate tables, windows, and other locations. The bunting flag is provided in a variety of sizes and materials. The invention is further directed to a method in which to manufacture the bunting flag in a cost-effective manner.

### CROSS-REFERENCE TO RELATED APPLICATIONS

This Application claims the benefit of U.S. Provisional Application No. 62/026068, filed Jul. 18, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to event decorations, and in particular to an event bunting flag and a related method. When preparing for a party, reception, or other event, decorators frequently face the need to set up decorations in a limited time frame and on a limited budget. Unfortunately, many types of decorations are very time-consuming and expensive, and require multiple trips up and down a stepladder. An event bunting flag, providing decorations for an event which can be set up in a very short time frame and manufactured cost-effectively, would resolve this problem.

### SUMMARY OF THE INVENTION

Accordingly, the invention is directed to an event bunting flag and a related method. The bunting flag provides decoration for holidays, birthdays, and other occasions. The bunting flag lays flat against a surface and does not requires a flag pole and can be used to decorate tables, windows, and other locations. The bunting flag is provided in a variety of sizes. The invention is further directed to a method in which to manufacture the bunting flag in a cost-effective manner.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a front view of the Happy Birthday and Happy New Year versions of the first exemplary embodiment folded, displaying the Happy Birthday flag 10A, the Happy New Year flag 10B, the upper hem 11, and the grommets 12.

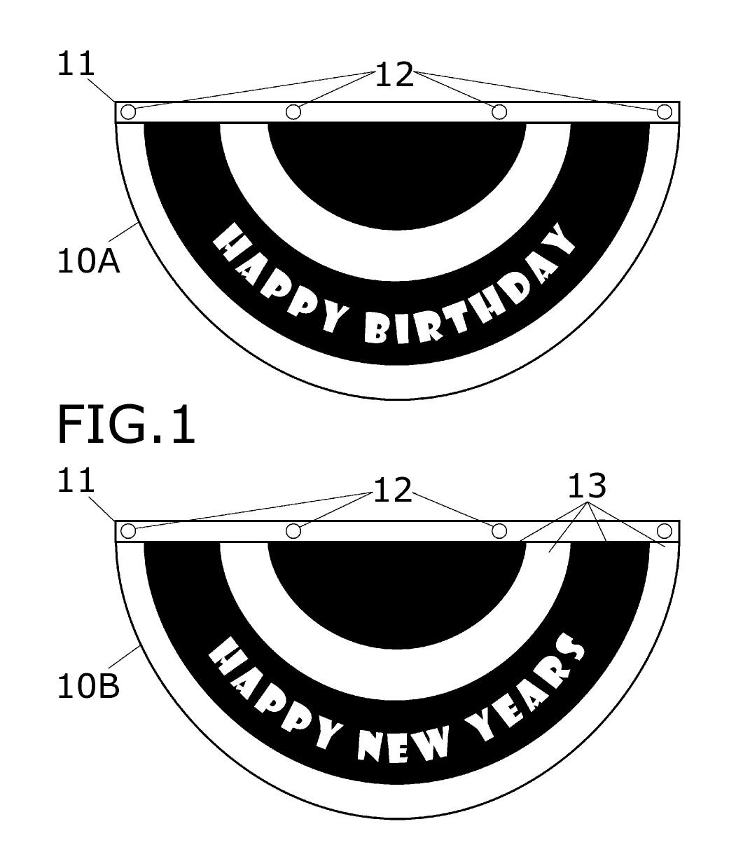

FIG. 2 is a front view of the first exemplary embodiment unfolded, displaying the grommets 12, levels 13, eyelets 14, top edge 15, left edge 16, seams 17, right edge 18, and bottom edge 19.

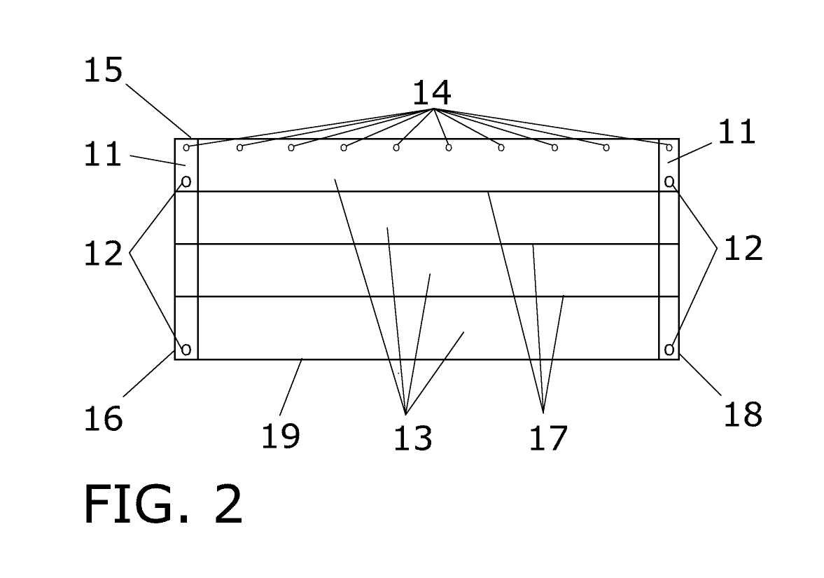

### DETAILED DESCRIPTION OF THE INVENTION

Referring now to the invention in more detail, the invention is directed to an event bunting flag.

The first exemplary embodiment comprises a semicircular bunting flag 10, provided in several versions such as a Happy Birthday version 10A and a Happy New Year version 10B. The bunting flag may have a plurality of levels 13. The curved lower edge bears a celebratory slogan, with concentric colored rings above it. The upper hem 11 is straight and may be easily and quickly affixed to a wall or the edge of a table, a plurality of grommets 12 are provided to enable the user to affix the bunting flag 10 with twine or rope.

The invention is further directed to a method in which to manufacture the bunting flag in a cost-effective manner. The manufacturing process cuts a plurality of pieces of cotton fabric eight inches wide and seventy-five inches long, these pieces of fabric are the levels 13. The levels 13 are sewn together lengthwise with a 0.25 inch seam 17 and zig-zag stitching, to bind the seam 17, excess fabric is trimmed to make a smooth seam 17. Zig-zag stitching is then applied around the entire bunting to prevent raveling, the left side 16 and right side 18 are hemmed by turning under 0.25 inch and stitching. The top edge 15 and bottom edge 19 are hemmed by turning under 0.25 inch and stitching.

The entire bunting is ironed to remove creases, and the seams 17 and hems are pressed. The bunting is then laid flat on an even surface, such as the floor or a sewing table. A mark is placed one inch inside and from the hemmed top side, the first and last eyelets 14 will go at these marks. The bunting is measured to evenly space ten eyelets 14. To fold the bunting the eyelets are overlapped from the outside in. The eyelets are then secured together. Grommets 12 are placed along the side edges to allow the bunting flag to me hung, optionally, a ring may be placed through each grommet 12.

To use the first exemplary embodiment, the user suspends the bunting flag 10 from a vertical surface such as a wall, or the edge of a horizontal surface such as a table. The bunting flag 10 may be suspended by its upper edge 11 and affixed to the mounting surface. Twine or rope may be threaded through the grommets 12 or the rings which may be attached to the grommets 12, or the user may affix the bunting flag 10 to the surface with tape, hook-and-loop fasteners, or a similar adhesive.

The bunting flag 10 is preferably manufactured from a flexible, durable material such as cotton or polyester fabric. The grommets 12 are preferably manufactured from a rigid, durable material such as stainless steel or brass. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An event bunting flag and related method of manufacture, comprising:
(a) a bunting flag having a top edge, left edge, right edge, and bottom edge;
(b) said bunting flag being of a semicircular shape when folded;
(c) said bunting flag being decorated with any one or more of the group of decorations of a solid color, a pattern of colors, a symbol, a logo, or text.
(d) said bunting flag having a plurality of eyelets; and
(e) said eyelets being even spaced along said top edge.

2. The event bunting flag of claim 1, wherein said bunting flag further comprises a plurality of levels; said levels being permanently affixed at a plurality of seams; said seams attaching a top edge of one of said plurality of levels to a bottom edge of another of said plurality of levels.

3. The event bunting flag of claim 1, further comprising a plurality of grommets; said grommets being located along said left edge and said right edge; said grommets being configured such that they may be used to hang said bunting flag.

4. The event bunting flag of claim 1, wherein said top edge is hemmed; said left edge is hemmed; said right edge is hemmed; and said bottom edge is hemmed.

5. The event bunting flag of claim 2, wherein said top edge is hemmed; said left edge is hemmed; said right edge is hemmed; and said bottom edge is hemmed.

6. The event bunting flag of claim 3, wherein said top edge is hemmed; said left edge is hemmed; said right edge is hemmed; and said bottom edge is hemmed.

7. The event bunting flag of claim 2, wherein said plurality of seams are sewn together using a zig-zag stitch.

8. The event bunting flag of claim 5, wherein said plurality of seams are sewn together using a zig-zag stitch.

9. An event bunting flag and related method of manufacture, comprising:
(a) a bunting flag having a top edge, left edge, right edge, and bottom edge;
(b) said bunting flag being of a semicircular shape when folded;
(c) said bunting flag being decorated with any one or more of the group of decorations of a solid color, a pattern of colors, a symbol, a logo, or text.
(d) said bunting flag having a plurality of eyelets;
(e) said eyelets being even spaced along said top edge;
and the method comprising:
(f) a manufacturer cutting a material into elongated rectangles;
(g) said manufacturer ironing said bunting flag;
(h) said manufacturer pressing said plurality of seams and said top edge, said left edge, said right edge, and said bottom edge;
(i) said manufacturer piercing said top edge, creating a plurality of eyelets;
(j) said eyelets being evenly spaced across said top edge;
(k) said manufacturer folding said bunting flag by overlapping said eyelets from the outmost said eyelet to the innermost said eyelet; and
(l) said manufacturer securing said plurality of eyelets together.

10. The event bunting flag and related method of manufacture of claim 9, wherein said bunting flag further comprises a plurality of levels; said levels being permanently affixed at a plurality of seams; said method further comprising said manufacturer attaching a top edge of one of said plurality of levels to a bottom edge of another of said plurality of levels creating said plurality of seams.

11. The event bunting flag and related method of manufacture of claim 9, wherein said bunting flag further comprises a plurality of grommets; said grommets being located along said left edge and said right edge; said grommets being configured such that they may be used to hang said bunting flag; wherein said method further comprises said manufacturer piercing said left edge and said right edge and affixing said plurality of grommets at said piercings.

12. The event bunting flag and related method of manufacture of claim 9, wherein said event bunting flag further comprises said top edge is hemmed; said left edge is hemmed; said right edge is hemmed; and said bottom edge is hemmed; wherein said method further comprises said manufacturer folding said top edge over and sewing a hem; said manufacturer folding said left edge over and sewing a hem; said manufacturer folding said right edge over and sewing a hem; and said manufacturer folding said bottom edge over and sewing a hem.

13. The event bunting flag and related method of manufacture of claim 10, wherein said event bunting flag further comprises said top edge is hemmed; said left edge is hemmed; said right edge is hemmed; and said bottom edge is hemmed; wherein said method further comprises said manufacturer folding said top edge over and sewing a hem; said manufacturer folding said left edge over and sewing a hem; said manufacturer folding said right edge over and sewing a hem; and said manufacturer folding said bottom edge over and sewing a hem.

14. The event bunting flag and related method of manufacture of claim 11, wherein said event bunting flag further comprises said top edge is hemmed; said left edge is hemmed; said right edge is hemmed; and said bottom edge is hemmed; wherein said method further comprises said manufacturer folding said top edge over and sewing a hem; said manufacturer folding said left edge over and sewing a hem; said manufacturer folding said right edge over and sewing a hem; and said manufacturer folding said bottom edge over and sewing a hem.

15. The event bunting flag and related method of manufacture of claim 10, wherein said plurality of seams are sewn together using a zig-zag stitch; said method further comprising said manufacturer sewing together said seams using a zig-zag stitch; and said manufacturer trimming away excess material from said seam.

16. The event bunting flag and related method of manufacture of claim 13, wherein said plurality of seams are sewn together using a zig-zag stitch; said method further comprising said manufacturer sewing together said seams using a zig-zag stitch; and said manufacturer trimming away excess material from said seam.
